(19) United States
(12) Patent Application Publication
(10) Pub. No.: US 2010/0054177 A1
(43) Pub. Date: Mar. 4, 2010

(54) METHOD AND SYSTEM OF USING IP MULTIMEDIA SYSTEM FOR CALL SETUP IN MOBILE SATELLITE SYSTEMS

(76) Inventors: Serdar Sahin, Plano, TX (US); Kasi Narayanaswamy, Irving, TX (US)

Correspondence Address: ERICSSON INC., 6300 LEGACY DRIVE, M/S EVR 1-C-11, PLANO, TX, 75024, US

(21) Appl. No.: 12/353,369

(22) Filed: Jan. 14, 2009

Related U.S. Application Data
(60) Provisional application No. 61/093,512, filed on Sep. 2, 2008.

(51) Int. Cl. H04B 7/185

(52) U.S. Cl. 370/316

(57) ABSTRACT

A system and method of using IP Multimedia System (IMS) for call setup in Mobile Satellite Systems. The method begins by a unit equipment (UE) originating a call to a second party. Next, secondary Packet Data Protocol (PDP) Context is initiated after originating the call. At least a portion of progress and acknowledgement message exchanges are handled by a Satellite Session Initiation Protocol Gateway (SSGW) in a Mobile Satellite System (MSS) on behalf of the UE without communicating with the UE. The call is then connected between the UE and the second party. A simplified Session Description Protocol (SDP) may be implemented for use between the UE and the SSGW to reduce the payload of Session Initiation Protocol (SIP) messaging. With a simplified SDP, one codec of the second party may be pre-provisioned in the SSGW.

### CROSS-REFERENCE TO RELATED APPLICATIONS

This application claims the benefit of U.S. Provisional Application No. 61/093,512, filed Sep. 2, 2008, the disclosure of which is incorporated herein by reference.

### BACKGROUND

The present invention relates to communications networks. More particularly, and not by way of limitation, the present invention is directed to a system and method using IP Multimedia System for call setup performance improvements in mobile satellite systems.

Advancements in terrestrial wireless network technologies such as 3GPP High-Speed Packet Access (HSPA), 3GPP2 Code Division Multiple Access (CDMA), Worldwide Interoperability for Microwave Access (Wimax) and wireline technologies are enabling existing and greenfield wireless operators to use IP Multimedia System (IMS) architecture to provide all IP multimedia communication services to their subscribers independent from the access network the subscriber is using. Voice calling, video calling, push-to-talk, media sharing, multimedia messaging and other services can be horizontally combined to enrich the user experience in ways similar to the Internet. Today's mobile satellite systems (MSS) are being built to leverage these benefits of the IMS-based design to provide terrestrial coverage without being constrained with the terrestrial radio access technology.

The IMS, as defined by 3GPP, merges telephony and Internet technology by providing an all-IP based architecture for the telecommunications industry. The IMS is based on the Session Initiation Protocol (SIP) and makes heavy use of the protocols defined within the Internet Engineering Task Force (IETF). The system offers a network of servers and databases that assist a user agent with the task of establishing and managing sessions. IMS uses the term sessions because the connections between users are no longer limited to voice services (a phone call). Sessions may be voice, video, text, or other services connecting two or more user agents together.

FIG. 1 is a simplified block diagram of a logical network IMS architecture. The IMS architecture includes a User Equipment (UE) 10, a Call Session Control Functions (CSCF) 12, a Home Subscriber Server (HSS) 14 and Application Servers (e.g., App Servers 16 and 18). The UE 10 is a device that contains a SIP User Agent that initiates or terminates sessions. The CSCF 12 is responsible for managing the sessions including security and interconnection. There are typically three types of CSCFs, a Proxy CSCF (P-CSCF), an Interrogating CSCF (I-CSCF), and a Serving CSCF (S-CSCF). The P-CSCF is situated at the edge of the network and is an entry point for the UE into the IMS core. The I-CSCF serves as the entry point into the network for peering networks. The I-CSCF also acts as the lookup function for finding the appropriate serving node for a subscriber. The S-CSCF is responsible for authenticating the UE 10 and managing ongoing sessions for the UE including invocation of applications. The S-CSCF communicates with the HSS in order to retrieve the UE authentication information. After the user has been authenticated, the S-CSCF again communicates with the HSS 14 to retrieve the user profile which specifies the services that a user has subscribed to and which application servers are to be invoked for those services.

The HSS 14 stores the relevant user data including authentication information and service data. As part of the user profile, initial Filter Criteria (iFC) are defined to indicate which application servers are to be invoked based on information in the signaling plane. The application servers (e.g., app servers 16 and 18) are invoked based on the iFCs that are stored in the user profile. The S-CSCF passes signaling onto an Application Server if the criteria defined in the iFC are met. Once invoked, the application server can now take part in the session and provide additional capabilities.

IMS provides an IP based framework where control and media traffic is separated. SIP, which is properly modified to account for the wireless environment, provides the control signaling. SIP is a “wordy” protocol and the transport of SIP signaling over terrestrial wireless links has been shown to be inefficient due to the scarce bandwidth and long round trip delays. It has been found that SIP-based call setup time, as compared to CS-based call setup time, is approximately twice as long. SIP compression was advised to partially overcome the long SIP call setup times. A satellite link only worsens the situation as the available bandwidth is considerably less and the round trip times of transmission are much longer. Radio level acknowledgments are suggested to prevent even more delays due to higher layer retransmissions.

### SUMMARY

The present invention provides a different approach by implementing improvements in SIP signaling with no impact on the IMS Core Network or IMS application servers and by taking advantage of inherent characteristics of mobile satellite systems, such as the limited number of usable codecs.

In one aspect, the present invention is directed at a method of using IP Multimedia System (IMS) for call setup in Mobile Satellite Systems. The method begins by a unit equipment (UE) originating a call to a second party. Next, secondary Packet Data Protocol (PDP) Context is initiated after originating the call. At least a portion of progress and acknowledgement message exchanges are handled by a Satellite Session Initiation Protocol Gateway (SSGW) in a Mobile Satellite System (MSS) on behalf of the UE without communicating with the UE. The messages may include 1XX session progress message exchanges and PRACK message exchanges handled by the SSGW on behalf of the UE. The call is then connected between the UE and the second party. A simplified Session Description Protocol (SDP) may be implemented for use between the UE and the SSGW to reduce the payload of Session Initiation Protocol (SIP) messaging. With a simplified SDP, one codec of the second party may be pre-provisioned in the SSGW.

In another aspect, the present invention is directed at a system for using IMS for call setup in Mobile Satellite Systems. The system includes a UE originating a call to a second party. A Secondary PDP Context is initiated after originating the call by the UE. The system also includes a SSGW in a MSS for handling at least a portion of progress and acknowledgement message exchanges on behalf of the UE. The system provides a connection between the UE and the second party. A simplified SDP may be implemented for use between the UE and the SSGW to reduce the payload of Session Initiation Protocol (SIP) messaging.

In still another aspect, the present invention is a node for using IMS for call setup in Mobile Satellite Systems. Preferably the node is a SSGW which handles at least a portion of progress and acknowledgement message exchanges in a MSS on behalf of a UE originating a call to a second party without communicating with the UE. The SSGW may use a simplified SDP to communicate with the UE.

### BRIEF DESCRIPTION OF THE DRAWINGS

In the following section, the invention will be described with reference to exemplary embodiments illustrated in the figures, in which:

FIG. 1 (prior art) is a simplified block diagram of a logical network IMS architecture;

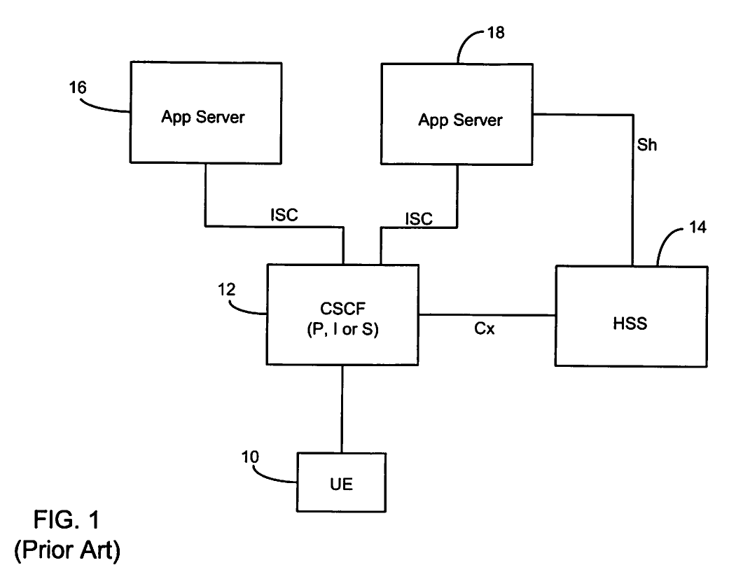

FIG. 2 (prior art) is a signaling diagram illustrating a Mobile Originated call flow through a Circuit Switched Satellite Gateway towards the Public Switched Telephony Network based on ETSI GMR-1 standards;

FIG. 3 (prior art) is a signaling diagram illustrating a Mobile Originated call flow for session establishment through an IMS Packet Switched network based on SIP;

FIG. 4 is a signaling diagram illustrating an improved IMS PS-based MSS MO call flow; and

FIG. 5 is a flow chart illustrating the steps of an improved IMS PS based call setup according to the teachings of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

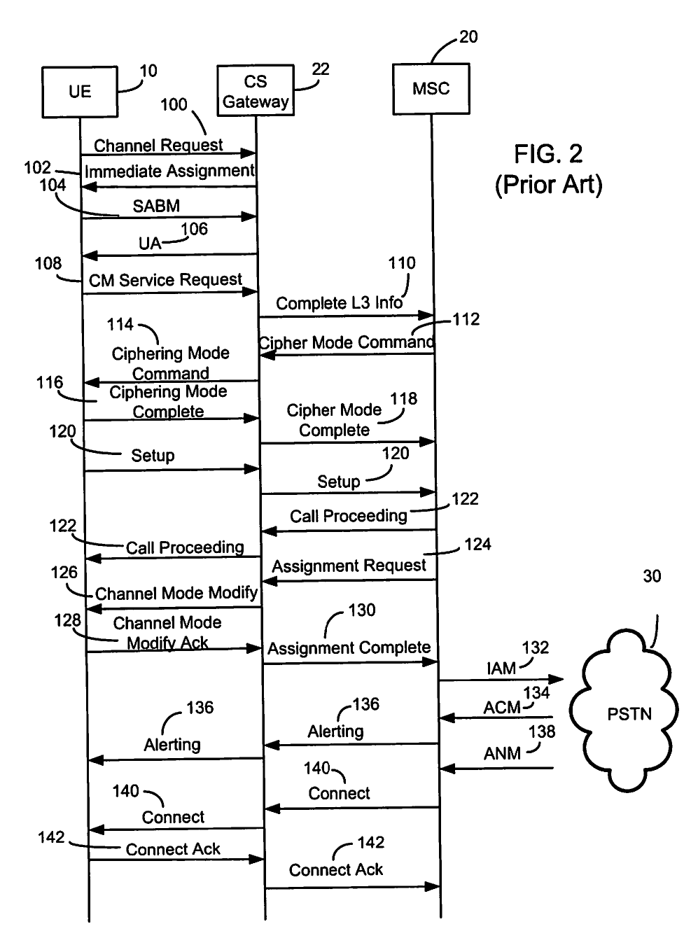

The present invention is a method and system of using IMS for call setup in MSSs. Although IMS is very well suited for terrestrial IP networks, because of the low data rates and the high propagation delay satellite environment, it is difficult to provide equivalent performance levels as seen in circuit switched systems. FIG. 2 is a signaling diagram illustrating a Mobile Originated call flow through a Circuit Switched (CS) Satellite Gateway towards the Public Switched Telephony Network (PSTN) 30 based on ETSI GMR-1 standards. The UE 10 first requests at 100 and gets assigned at 102 a signaling channel in order to send call setup messages. After the Set Asynchronous Balanced Mode (SABM) at 104 and Unnumbered Acknowledgement (UA) at 106 perform a handshake, the UE 10 sends the call request via a Cipher Mode (CM) Service Request at 108. An MSC 20 may optionally authenticate the UE at this point with adjustable frequency. Once ciphering is initiated at 110, 112, 114, 116, and 118, the UE 10 sends a Setup message 120 to the MSC 20 which contains further information about the call. The MSC acknowledges the validity of information via a Call Proceeding message 122. The MSC 20 then requests a CS Gateway 22 at 124 to reserve a voice circuit between the MSC 20 and the CS Gateway 22. The CS Gateway first instructs the UE to move to a voice traffic channel at 126 and, upon the UE's confirmation at 128, responds to the MSC with an Assignment Complete message at 130. The MSC 20 may then initiate the call towards the PSTN 30 with an Initial Address Message (IAM) at 132. If the destination phone starts ringing, the PSTN responds with an Address Complete Message (ACM) at 134. The MSC then sends an Alerting message 136 to the UE. Once the destination phone picks up, the PSTN sends an Answer Message (ANM) 138, which results in the MSC establishing a bi-directional path to the UE via a Connect and a Connect Acknowledge message exchange at 140 and 142.

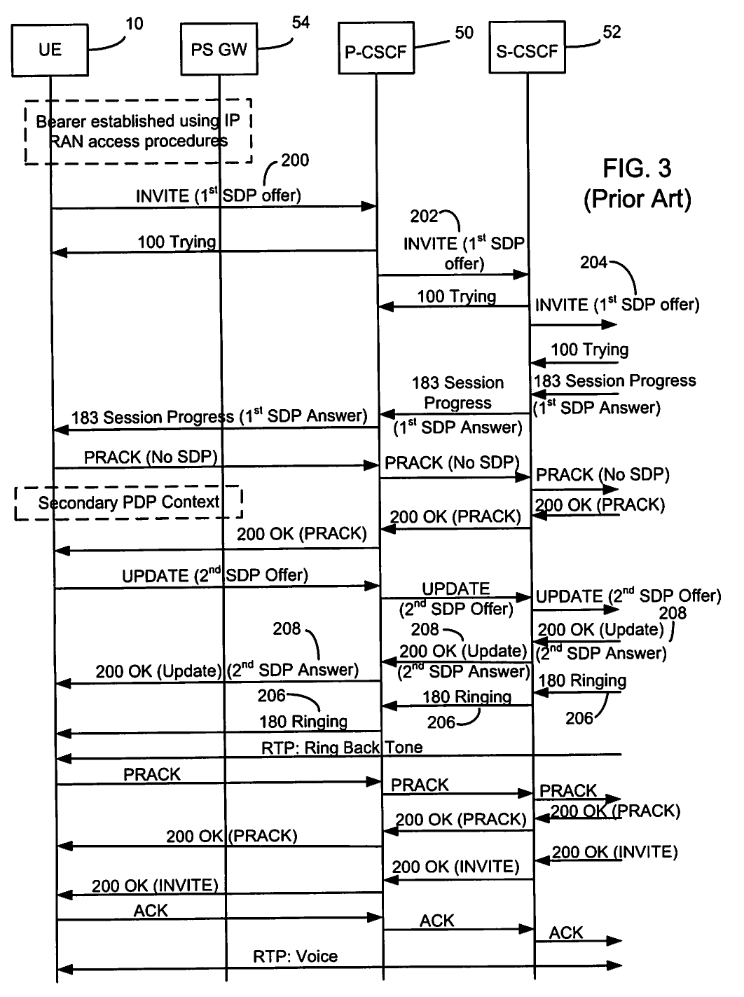

FIG. 3 is a signaling diagram illustrating a Mobile Originated (MO) call flow for session establishment through an IMS Packet Switched (PS) network based on SIP. The session is initiated by the UE using a SIP INVITE message at 200. The INVITE message from UE is forwarded to a home P-CSCF 50 of the user. The P-CSCF 50 forwards the INVITE message to a S-CSCF 52 at 202, which executes the originating service control procedures for the UE 10 and forwards the call to the terminating network at 204. Upon receiving the provisional response(s), such as the 180 Ringing message and final 200 OK response from the terminating network, the S-CSCF 52 forwards these messages to the P-CSCF 50. The P-CSCF, in turn, forwards these messages to the UE via a PS gateway 54. The Original INVITE message from the UE has the offer in Session Description Protocol (SDP) protocol. This offer includes the set of media streams and codecs the UE wishes to use, along with the IP addresses and ports the offerer would like to use to receive the media. The 180 Ringing response 206 or optionally, the 200 OK response 208, has the answer to the offer. This SDP answer has a matching media stream for each stream in the offer, indicating whether the stream is accepted or not, along with the codecs that will be used and the IP addresses and ports that the terminating UE wants to use to receive media.

Table 1 provides information on the calculated delay estimate for a CS-based Mobile Originated Call. The delays are based on assumptions that a one-way propagation delay through a GEO satellite is 270 ms and one-way processing delay is 150 ms. A Stand-alone Dedicated Control Channel (SDCCH) is sent every 320 ms with a 50 ms block transmission delay and a Fast Associated Control Channel (FACCH) is sent every 160 ms with a 125 ms block transmission delay. A 100 ms processing delay is also considered for a CS gateway for Channel Mode Modify related processing. Another 1000 ms is allocated for the PSTN network to respond to an IAM message. No assumptions were made on any retransmissions in the network. Finally, the Total Delay is calculated as the time spent from transmission of Channel Request from UE to the receipt of Alerting at UE.

TABLE 1
CS Call Setup Time

| Message or Event | Delay (ms) |
|---|---|
| Channel Assignment | 840 |
| SABM/UA | 840 |
| \|---------- CM Service Request ---------->\| | 1110 |
| \|<-----Cipher Mode ------\| | 790 |
| \|---------- Setup ---------->\| | 1430 |
| \|<-----Call Proceeding ------\| | 790 |
| \|<-----Channel Mode Modify ------\| | 100 |
| \|---------- Channel Mode Modify Ack ---------->\| | 705 |
| IAM to PSTN, ACM from PSTN | 1000 |
| \|<--------- Alerting ----------\| | 705 |
| Total Delay | 8310 |

Table 2 shows the calculated delay estimate for an IMS PS based Mobile Originated Call. To estimate the total delay, the same methodology discussed for Table 1 was used in this scenario with some exceptions. Round Trip Delay (RTT) is assumed to be 840 ms, which is in line with the CS calculation. A 4 kbps channel, instead of 9.6 kbps channel, is assumed as this is more appropriate for mobile satellite systems where the overall capacity is drastically less than terrestrial networks. The PSTN delay was not included as PSTN signaling happens in parallel between INVITE and 200 OK responses to INVITE and does not create additional delays. Finally, a three second duration is assumed for the secondary Packet Date Protocol (PDP) Context Activation.

TABLE 2
IMS PS Call Setup Time

| Message or Event | Delay (ms) |
|---|---|
| Uplink Assignment | 840 |
| \|---------- INVITE --------->\| | 1660 |
| \|<-- 183 Session progress ---\| | 1420 |
| \|---------- PRACK ---------->\| | 920 |
| \|<----- 200 OK (PRACK) ------\| | 1020 |
| \|<...... Secondary PDP Context .......>\| | 3000 |
| \|---------- UPDATE ---------->\| | 1660 |
| \|<----- 200 OK (UPDATE) ------\| | 1320 |
| \|<------ 180 Ringing --------\| | 880 |
| \|---------- PRACK ---------->\| | 920 |
| \|<----- 200 OK (PRACK) ------\| | 1020 |
| \|<--------- 200 OK ----------\| | 1320 |
| Total Delay | 15980 |

Although the estimations in Tables 1 and 2 are based on assumptions, the delay in the CS scenario of Table 1 has been verified by actual calls through a commercial system and found to be accurate. In the case of IMS, PS based call setups, RTT of 840 ms and 3 second Context Activation are considered as lower bounds. A simple “ping” round trip delays through a commercial MSS packet data system tests reveal delays of approximately 800 ms. As the analysis above shows, IMS PS based call setup time can be more than twice as long its CS counterpart for MO calls over a satellite system without utilizing improvements.

The present invention provides improvements in SIP protocol messaging which significantly improves the latency in call set-up and establishment. The present invention decreases the number of SIP messages. In the present invention the number of 1xx messages exchanged during call-setup and establishment are reduced, thereby resulting in significantly less call setup times. The Offer and Answer model may be preserved in that the Offer is carried in the INVITE request and the Answer is carried over the 200 OK response. In the preferred embodiment of the present invention, a Satellite SIP gateway (SSGW) 60 is used to support this messaging in such a way that interoperability with the standard SIP components and network is supported as the SSGW provides the appropriate message adaptation and translations.

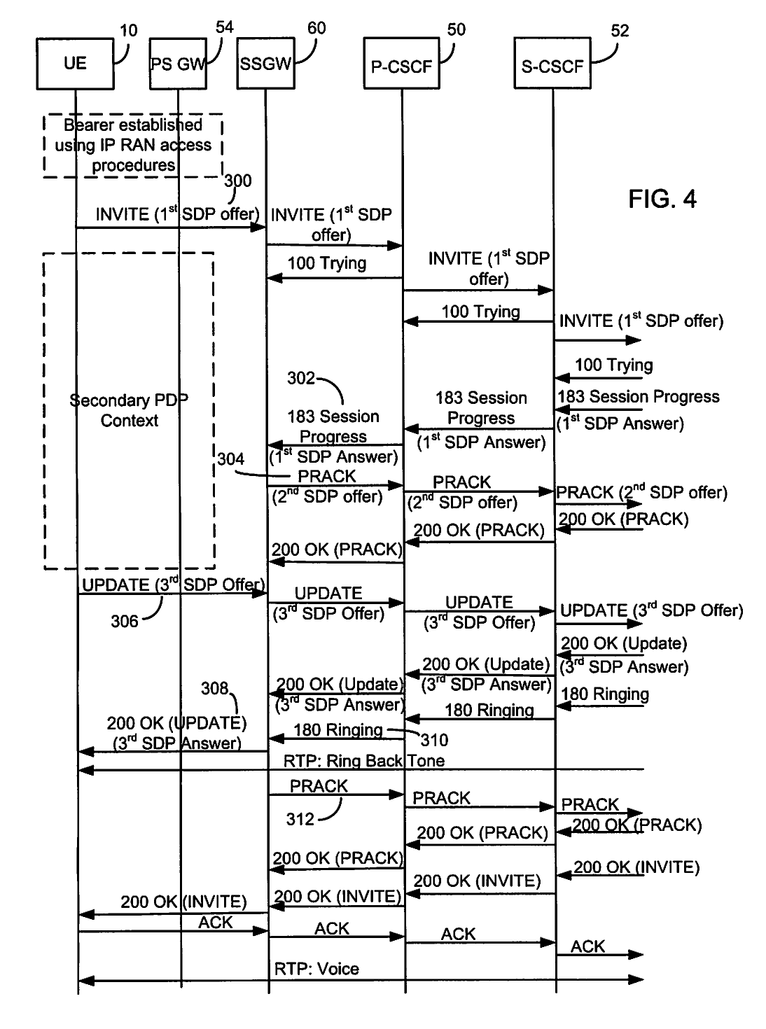

FIG. 4 is a signaling diagram illustrating an improved IMS PS-based MSS MO call flow. The call flow includes a Secondary PDP Context Activation which is started immediately after the INVITE message 300 is sent. The UE 10 presumes that the proposed codec(s) are acceptable either by the called party or by the use of a transcoding function within the IMS Network. Thus, the SSGW 60 does not need to send a 1st SDP Answer to the UE 10. The SSGW 60 handles a 183 Session Progress message 302 and a PRACK message 304 exchanges on behalf of the UE 10. The SSGW informs the UE only in case of failures. The UE still sends an UPDATE message 306 to inform the called party from completion of resource reservation. In the remaining portion of the call flow, the SSGW 60 sends a 200 OK (UPDATE) message 308 to the UE after it receives a 180 Ringing 310. This allows the UE to understand that the called party is ringing without the need to receive the 180 Ringing message. The SSGW also sends a PRACK message 312 acknowledging the 180 Ringing message 310 on behalf of the UE. The resulting improvement in call setup time is approximately 6.6 seconds. Table 3 shows this improved IMS PS based call setup time.

TABLE 3
Improved IMS PS based Call Setup Time

| Message or Event | Delay (ms) |
|---|---|
| Uplink Assignment | 840 |
| \|---------- INVITE --------->\| | 1660 |
| \|<...... Secondary PDP Context .......>\| | 3000 |
| \|---------- UPDATE ---------->\| | 1660 |
| \|<----- 200 OK (UPDATE) ------\| | 900 |
| \|<--------- 200 OK ----------\| | 1320 |
| | 9380 |

In another embodiment, a simplified version of the SDP protocol may be employed with a minimalist sub-set of mandatory attributes. In the Satellite environment, a much simplified codec usage mechanism is used wherein there is mostly only one codec which is used by end-point devices. This codec and its associated attributes may be handled as part of an end-point configuration and pre-provisioning process, as opposed to included in a SDP payload of the SIP message. This results in a smaller payload and, thus, a smaller SIP session set-up message. The SSGW 60 may be used to make the pre-provisioning process transparent to the rest of the network. Table 4 illustrates an improved IMS PS based call setup time with additional SDP payload reduction. Based on payload ratios observed in operational systems, it is assumed that about a twenty five percent reduction may be achieved in the SIP messages carrying an SDP payload by pre-provisioning. The resulting additional improvement in call setup time is about 0.85 seconds as shown in Table 4. With both these improvements in call setup, the resulting final call setup time is comparable to the CS Call setup shown in Table 1.

TABLE 4
Improved IMS PS based Call Setup Time with Additional
SDP Payload Reduction

| Message or Event | Delay (ms) |
|---|---|
| Uplink Assignment | 840 |
| \|---------- INVITE --------->\| | 1350 |
| \|<...... Secondary PDP Context .......>\| | 3000 |
| \|---------- UPDATE ---------->\| | 1350 |
| \|<----- 200 OK (UPDATE) ------\| | 675 |
| \|<--------- 200 OK ----------\| | 1320 |
| | 8535 |

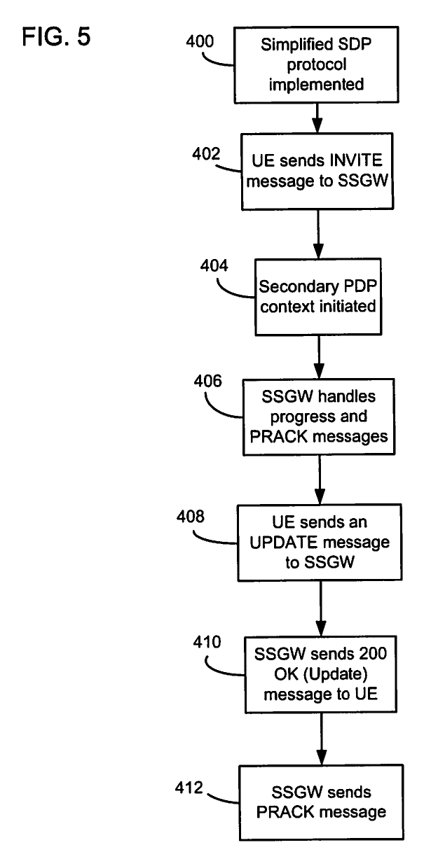

FIG. 5 is a flow chart illustrating the steps of an improved IMS PS based call setup according to the teachings of the present invention. With reference to FIGS. 4 and 5, the method will now be explained. In step 400, the call flow may optionally utilize a simplified SDP protocol. The UE 10 sends an INVITE message 300 to the SSGW 60 in step 402. Next, in step 404, secondary PDP Context Activation is started immediately after sending the INVITE message in step 402. The SSGW preferably withholds sending a 1^{st} SDP answer message to the UE. In step 406, the SSGW handles 183 Session Progress and PRACK message exchanges on behalf of the UE. The UE is preferably only informed in case of a failure. Next, in step 408, the UE sends an UPDATE message 306 to the SSGW. In step 410, the SSGW sends a 200 OK (UPDATE) message 308 to the UE after receiving a 180 Ringing message 310. In step 412, the SSGW sends a PRACK message 312 acknowledging receipt of the 180 Ringing message 310 on behalf of the UE. For example, in contrast to terrestrial networks, only one codec is used by an end-point device (i.e., the UE). The codec may be pre-provisioned as part of an end-point configuration. Thus, a smaller payload and smaller SIP session set-up message may be employed, thereby further reducing the delays in the call flow.

Although discussions have been centered on Mobile Originated Call Setup, the present invention may be employed equally well to other types of SIP sessions, including, but not limited to, Mobile Terminated Calls and Multimedia Sessions.

In addition, the SIP improvements of the present invention have no impact on IMS Core Network or IMS application servers. The SSGW provides all the support for the appropriate message adaptation and translations.

The present invention provides many advantages over existing Mobile Satellite Systems. With the use of the present invention, IMS may be employed in current and future Mobile Satellite System deployments. The present invention applies equally well to IMS services with all current and future MSS Physical Layer access technologies, such as CDMA, WCDMA, TDMA and Wimax as the call setup latency is driven by the number of SIP messages exchanged over the air, the size of each SIP message, and the speed of the over the air connection.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A method of using IP Multimedia System for call setup in Mobile Satellite Systems, the method comprising the steps of:
originating a call by a unit equipment (UE) to a second party;
initiating Secondary Packet Date Protocol (PDP) Context after originating the call;
handling at least a portion of progress and acknowledgement message exchanges by a Satellite Session Initiation Protocol Gateway (SSGW) in a Mobile Satellite System (MSS) on behalf of the UE; and
connecting the call between the UE and the second party.

2. The method according to claim 1 wherein the step of originating a call by a UE includes sending an INVITE message by the UE to the SSGW.

3. The method according to claim 2 wherein the Secondary PDP Context is activated immediately after the UE sends the INVITE message.

4. The method according to claim 1 wherein the step of handling at least a portion of progress and acknowledgement messages includes handling the message exchanges without communicating with the UE.

5. The method according to claim 4 wherein the step of handling at least a portion of progress and acknowledgement message exchanges includes handling 1xx session progress message exchanges by the SSGW on behalf of the UE.

6. The method according to claim 5 wherein the 1XX session progress message exchanges are 183 Session Progress message exchanges.

7. The method according to claim 5 wherein the step of handling at least a portion of progress and acknowledge message exchanges includes handling PRACK message exchanges by the SSGW on behalf of the UE.

8. The method according to claim 1 further comprising the step of sending an UPDATE message by the UE to inform the second party of completion of resource reservation.

9. The method according to claim 1 further comprising the step of sending an OK (UPDATE) message by the SSGW to the UE acknowledging receipt of a ring message.

10. The method according to claim 9 further comprising the step of sending an acknowledgement message by the SSGW acknowledging receipt of the ring message on behalf of the UE.

11. The method according to claim 1 wherein the SSGW withholds sending a first Session Description Protocol answer message to the UE.

12. The method according to claim 1 further comprising the step of implementing a simplified Session Description Protocol (SDP) during message exchanges between the UE and the SSGW.

13. The method according to claim 12 wherein the step of implementing a simplified SDP includes using only one codec for the second party.

14. The method according to claim 13 wherein the codec is pre-provisioned by the SSGW as part of the second party configuration.

15. A system for using IP Multimedia System for call setup in Mobile Satellite Systems, the system comprising:
a unit equipment (UE) originating a call to a second party;
means for initiating Secondary Packet Date Protocol (PDP) Context after originating the call by the UE;
a Satellite Session Initiation Protocol Gateway (SSGW) in a Mobile Satellite System (MSS) for handling at least a portion of progress and acknowledgement message exchanges on behalf of the UE; and
means for connecting the call between the UE and the second party.

16. The system according to claim 15 wherein the UE originates the call by sending an INVITE message to the SSGW.

17. The system according to claim 16 wherein the Secondary PDP Context is activated immediately after the UE sends the INVITE message.

18. The system according to claim 15 wherein the SSGW handles at least a portion of progress and acknowledgement messages without communicating with the UE.

19. The system according to claim 18 wherein the progress and acknowledgement message exchanges includes 1XX session progress message exchanges.

20. The system according to claim 19 wherein the 1XX session progress message exchanges are 183 Session Progress message exchanges.

21. The system according to claim 19 wherein the acknowledge message exchanges includes PRACK message exchanges.

22. The system according to claim 15 wherein the UE sends an UPDATE message to inform the second party of completion of resource reservation.

23. The system according to claim 15 wherein the SSGW sends an OK (UPDATE) message to the UE acknowledging receipt of a ring message.

24. The system according to claim 15 wherein the SSGW withholds sending a first Session Description Protocol answer message to the UE.

25. The system according to claim 15 wherein a simplified Session Description Protocol (SDP) is used during message exchanges between the UE and the SSGW.

26. The system according to claim 25 wherein the simplified SDP includes using only one codec for the second party.

27. The system according to claim 26 wherein the codec is pre-provisioned by the SSGW as part of the second party configuration.

28. A node for using IP Multimedia System for call setup in Mobile Satellite Systems, the node comprising:
means for handling at least a portion of progress and acknowledgement message exchanges in a Mobile Satellite System (MSS) on behalf of a unit equipment (UE) originating a call to a second party without communicating with the UE.

29. The node according to claim 28 wherein the node is a Satellite Session Initiation Protocol Gateway (SSGW).

30. The node according to claim 29 wherein the progress and acknowledgement message exchanges includes 1XX session progress message exchanges.

31. The node according to claim 30 wherein the 1XX session progress message exchanges are 183 Session Progress message exchanges.

32. The node according to claim 30 wherein the acknowledge message exchanges includes PRACK message exchanges.

33. The node according to claim 29 wherein the SSGW withholds sending a first Session Description Protocol answer message to the UE.

34. The node according to claim 29 wherein a simplified Session Description Protocol (SDP) is used during message exchanges between the UE and the SSGW.

35. The node according to claim 34 wherein a codec of the second party is pre-provisioned by the SSGW as part of the second party configuration.
